(19) United States
(12) Patent Application Publication
(10) Pub. No.: US 2006/0139941 A1
(43) Pub. Date: Jun. 29, 2006

(54) Vehicle light structure

(76) Inventor: Yu-Chu Lin, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/359,591

(22) Filed: Feb. 23, 2006

Related U.S. Application Data
(63) Continuation-in-part of application No. 10/937,279, filed on Sep. 10, 2004.

(51) Int. Cl. F21V 1/00

(52) U.S. Cl. 362/509

(57) ABSTRACT

A vehicle light structure includes a reflection bracket, a light convergence ring and light emission elements. The reflection bracket is integrally formed with a vehicle light and comprises a base, an inner ring and an outer ring to form a passage thereat for the light convergence ring to seat therein. The base is formed with a wavy-like surface having peaks and valleys. The light emission elements are disposed at the valleys of the base. The light convergence ring comprises a wavy-like surface having peaks and valleys corresponding to the wavy-like surface of the base. The wavy-like surface of the light convergence ring comprises corrugated light accumulating surfaces thereon. The passage of the reflection bracket and the light accumulating surfaces of the light convergence ring reflect and refract the light from the light emission elements as an auxiliary light device.

This application is a continuation in part of my application filed Sep. 10, 2004, Ser. No. 10/937,279.

### BACKGROUND OF THE INVENTION

1. Field of the Invention

This invention relates to a vehicle light structure, and more particularly to a reflection bracket having a light convergence ring to reflect light as an auxiliary light device.

2. Description of the Prior Art

A traditional vehicle light uses a reflection bracket to increase the luminance of the light. However, if the vehicle encounters heavy frog or reaches to a dark place, the vehicle light may be too weak for the driver, in particular to the situation when there is an incoming vehicle.

In view of this, a new structure was derived, which adds a light convergence ring to the headlight to enhance the light. This design simply provides extra light from the light convergence ring other than the light itself, and is not enough at a darker or foggy site.

### SUMMARY OF THE INVENTION

It is the primary object of the present invention to provide a vehicle light structure, which provides a more bright light.

It is another object of the present invention to provide a vehicle light structure, which is energy conservative.

It is a further object of the present invention to provide a vehicle light structure, which has a longer service life.

### SUMMARY OF THE INVENTION

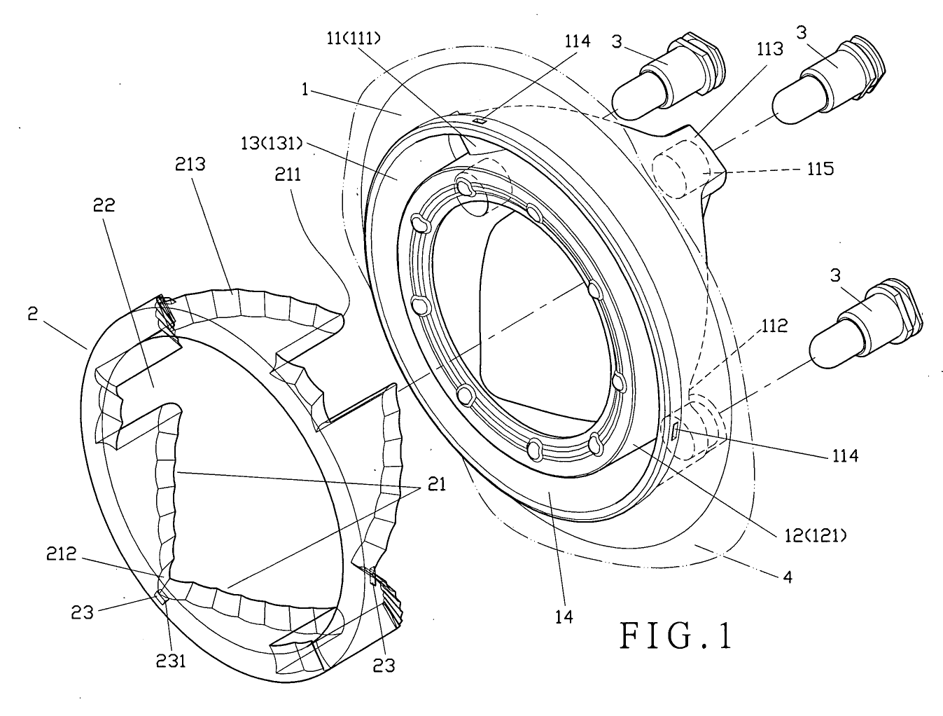

FIG. 1 is an exploded view of the present invention;

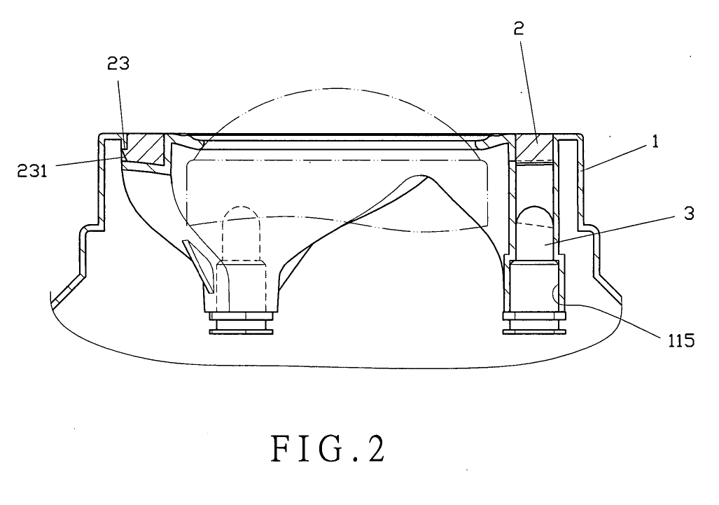

FIG. 2 is a side cross-sectional view of the present invention; and

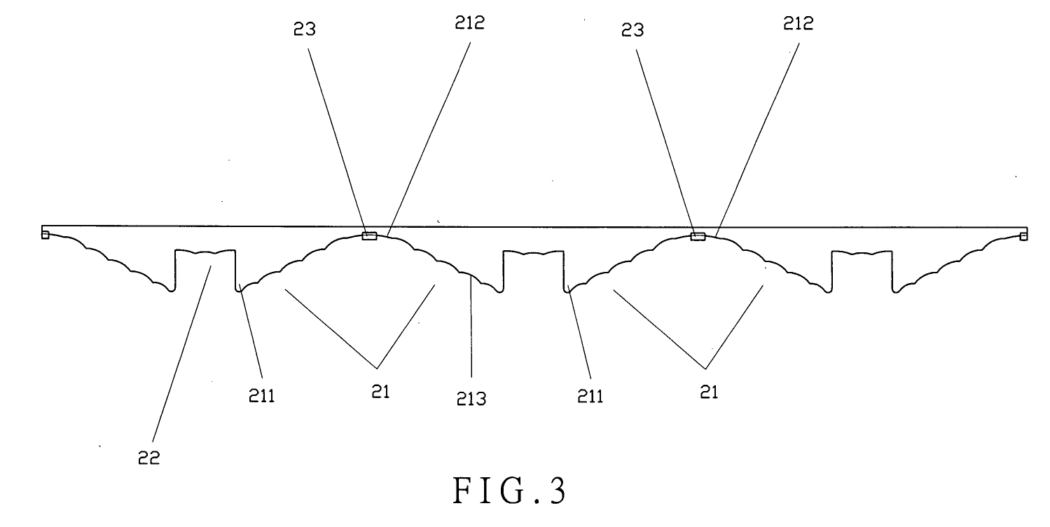

FIG. 3 is a diagram of a light convergence ring of the present invention.

### DETAILED DESCRIPTION OF THE PREFERRED EMBODIMENT

As shown in FIG. 1, the present invention comprises a reflection bracket 1, a light convergence ring 2 and light emission elements 3.

The reflection bracket 1, as show in FIGS. 1, 2 and 3, is integrally formed with a light base 4 and comprises a base 11, an inner ring 12 and an outer ring 13. All of which are provided with mirror surfaces so that the base 11 has a first reflection surface 111, the inner ring 12 has a second reflection surface 121 and the outer ring 13 has a third reflection surface 131. The base 11 has a wavy-like surface having peaks 112 and valleys 113. Each peak 112 comprises a trough 114 either thereon or at its side thereof. Each valley 113 comprises a hole 115 thereof. A passage 14 is formed in between the base 11, the inner ring 12 and the outer ring 13.

The light convergence ring 2, as shown in FIGS. 1, 2 and 3, is a transparent ring corresponding to the passage 14 of the reflection bracket 1, and comprises a wavy-like surface 21 having peaks 211 and valleys 212. The wavy-like surface 21 comprises serrate light accumulating surfaces 213. The light convergence ring 2 comprises notches 22 corresponding to the holes 115 of the reflection bracket 1 to receive light emission elements 3 therein so that the light from the light emission elements 3 may penetrates through the light convergence ring 2 and refracts through the light accumulating surfaces 213 and reflects through the first reflection surface 111, the second reflection surface 121 and the third reflection surface 131 of the reflection bracket 1. In order to secure the light convergence ring 2 to the reflection bracket 1 accurately, mortises 23 are formed around the light convergence ring 2 corresponding in position to the troughs 114 of the reflection bracket 1. Each mortise 23 has a pushing surface 231 at the bottom thereof.

The light emission elements 3 provide illumination, which may be xenon bulbs, halogen bulbs, light emitting diodes or any other kind, and are to be seated in the holes 115 of the reflection bracket 1 as well as the notches 22 of the light convergence ring 2.

To assemble the present invention, as shown in FIGS. 1 and 2, the light emission elements 3 are disposed in the holes 115 of the reflection bracket 1, and the mortises 23 of the light convergence ring 2 are engaged with the troughs 114 of the reflection bracket 1 to secure the light convergence ring 2 to the passage 14 of the reflection bracket 1, thus when the light emission elements 3 are activated, the light refracts through the light accumulating surfaces 213 of the light convergence ring 2 and reflects through the first reflection surface 111, the second reflection surface 121 and the third reflection surface 131 of the reflection bracket 1, more importantly, the first reflection surface 111 provides a wave form that shrinks the light passage from wide to narrow, and an even bright light effect.

What is claimed is:

1. A vehicle light structure comprising:
a reflection bracket integrally informed with a vehicle light, said reflection bracket comprising a base, an inner ring, and an outer ring to form a passage thereat, said base being formed with a wavy-like surface having peaks and valleys;
a light convergence ring, said light convergence ring being a transparent ring corresponding to said passage of said reflection bracket and comprising a wavy-like surface having peaks and valleys corresponding to said base of said reflection bracket, said wavy-like surface comprising corrugated light accumulating surfaces thereon;
light emission elements disposed to the valleys of said reflection bracket.

2. The vehicle light structure, as recited in claim 1, wherein said reflection bracket comprises troughs at the peaks of said reflection bracket.

3. The vehicle light structure, as recited in claim 2, wherein said light convergence ring comprises mortises corresponding in position to said troughs of said reflection bracket.

4. The vehicle light structure, as recited in claim 3, wherein each of said mortises of said light convergence ring comprises a pushing surface.

5. The vehicle light structure, as recited in claim 1, wherein the valleys of said reflection bracket are provided with holes.

6. The vehicle light structure, as recited in claim 5, wherein said light convergence ring comprises notches corresponding in position to said holes of said reflection bracket.
